(19) United States
(12) Patent Application Publication
(10) Pub. No.: US 2018/0075324 A1
(43) Pub. Date: Mar. 15, 2018

(54) INFORMATION PROCESSING APPARATUS, INFORMATION PROCESSING METHOD, AND COMPUTER READABLE STORAGE MEDIUM

(71) Applicant: YAHOO JAPAN CORPORATION, Tokyo (JP)

(72) Inventor: Nobuhiro KAJI, Tokyo (JP)

(21) Appl. No.: 15/690,921

(22) Filed: Aug. 30, 2017

(30) Foreign Application Priority Data
Sep. 13, 2016 (JP) 2016-178495

(51) Int. Cl. G06K 9/62; G06K 9/72

(52) U.S. Cl. CPC G06K 9/6276; G06K 9/72; G06K 9/623; G06K 9/6269

(57) ABSTRACT

An information processing apparatus according to the present application includes a conversion unit, au update unit, a generation unit, and a first learning unit. The conversion unit converts input target data into a feature vector. The update unit updates, by using the target data as first learning data, noise distribution data indicating a relationship between noise data extracted from the first learning data and a probability value. The generation unit generates noise data by using the noise distribution data updated by the update unit. The first learning unit learns a conversion process performed by the conversion unit by using the first learning data and the noise data.

### CROSS-REFERENCE TO RELATED APPLICATION(S)

The present application claims priority to and incorporates by reference the entire contents of Japanese Patent Application No. 2016-178495 filed in Japan on Sep. 13, 2016.

### BACKGROUND OF THE INVENTION

### 1. Field of the Invention

The present invention relates to an information processing apparatus, an information processing method, and a computer readable storage medium.

### 2. Description of the Related Art

Conventionally, a topic analysis device that assigns a label corresponding to a topic, such as “politics” or “economics”, to classification target data, such as text data, an image, or audio, is known (see Japanese Laid-open Patent Publication No. 2013-246586). The topic analysis device is preferably used in the field of social networking services (SNSs).

The topic analysis device converts the classification target data into vector data, and assigns a label on the basis of the converted vector data. Furthermore, the topic analysis device can improve the accuracy of label assignment by performing learning by using document data (training data) to which a label is assigned in advance.

However, the topic analysis device disclosed in Japanese Laid-open Patent Publication No. 2013-246586 performs a learning process on a classification unit that classifies data by assigning labels, but is not able to perform a learning process on a conversion unit that converts the classification target data into vector data.

### SUMMARY OF THE INVENTION

It is an object of the present invention to at least partially solve the problems in the conventional technology.

An information processing apparatus according to the present application includes: (i) a conversion unit that converts input target data into a feature vector, (ii) an update unit that updates, by using the target data as first learning data, noise distribution data indicating a relationship between noise data extracted from the first learning data and a probability value, (iii) a generation unit that generates noise data by using the noise distribution data updated by the update unit, and (iv) a first learning unit that learns a conversion process performed by the conversion unit by using the first learning data and the noise data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a use environment of a data classification device 100 according to an embodiment;

FIG. 2 is a block diagram illustrating a detailed configuration of the data classification device 100 according to the embodiment;

FIG. 3 is a schematic diagram illustrating an example of a word vector table TB according to the embodiment;

FIG. 4 is a schematic diagram illustrating an example of a method of calculating a feature vector V according to the embodiment;

FIG. 5 is a schematic diagram for explaining a label assignment process according to the embodiment;

FIG. 6 is a block diagram illustrating a detailed configuration of a learning device 170 according to the embodiment;

FIG. 7 is a schematic diagram illustrating an example of first learning data D1 according to the embodiment;

FIG. 8 is a schematic diagram illustrating an example of noise distribution data D3 according to the embodiment;

FIG. 9 is a schematic diagram illustrating a noise distribution q(c) as an example of the noise distribution data D3 according to the embodiment;

FIG. 10 is a schematic diagram illustrating an example of second learning data D2 according to the embodiment;

FIG. 11 is a flowchart illustrating the label assignment process according to the embodiment;

FIG. 12 is a flowchart illustrating a learning process (a first learning process) of learning a conversion process performed by a feature converter 130 according to the embodiment;

FIG. 13 is a flowchart illustrating a learning process (a second learning process) of learning a classification process performed by a classification unit 141 according to the embodiment;

FIG. 14 is a schematic diagram illustrating an example of a hardware configuration of the data classification device 100 according to the embodiment; and

FIG. 15 is a block diagram illustrating a detailed configuration of a data classification device 100 according to another embodiment.

### DETAILED DESCRIPTION OF THE PREFERRED EMBODIMENTS

Embodiments of an information processing apparatus, an information processing method, and a computer readable storage medium according to the present application will be described below with reference to the drawings. In the embodiments, a data classification device will be described as one example of the information processing apparatus. The data classification device is, for example, a device that handles data posted in an SNS in real time as classification target data, and assigns a label, such as “politics”, “economics”, or “sports”, in order to support classification of the posted data according to subject. The data classification device may be a device that provides, through a cloud service, a classification result to a server device that manages the SNS or the like, or may be a device that is built in the server device.

The data classification device converts the classification target data into a feature representation, assigns a label to the classification target data on the basis of the feature representation, and learns the process of converting the classification and the process of assigning the label, to thereby assign an appropriate label to the classification target data. In the following descriptions, as one example, the feature representation is vector data and the classification target data is text data including a plurality of words.

### 1. Use Environment of Data Classification Device

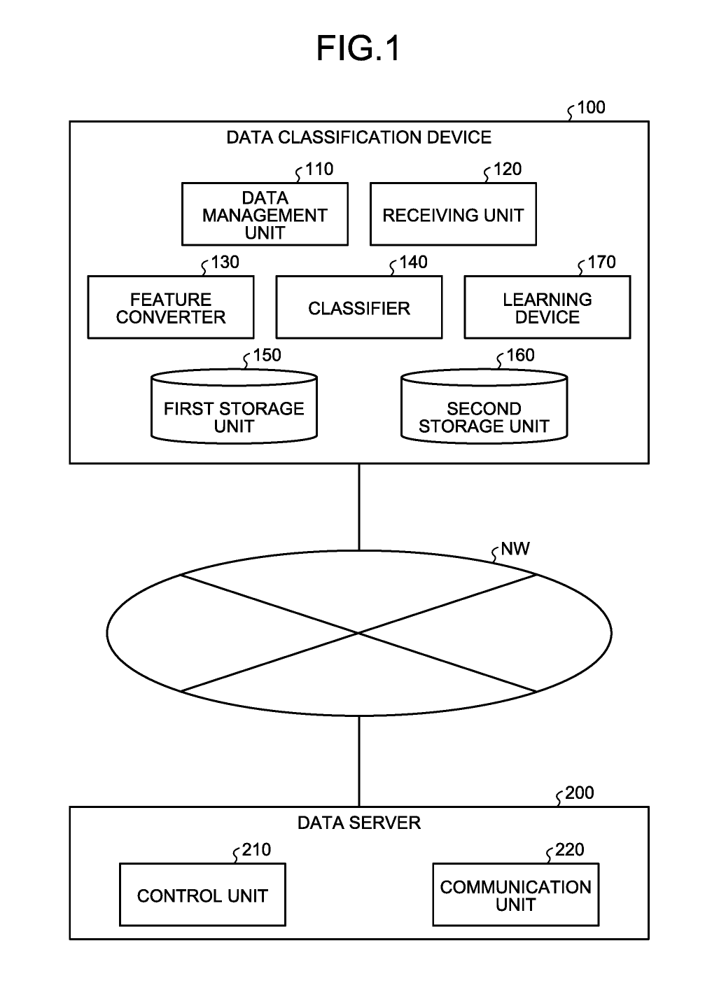

FIG. 1 is a schematic diagram illustrating a use environment of a data classification device 100 according to an embodiment. The data classification device 100 of the embodiment communicates with a data server 200 through a network NW. The network NW includes, for example, a part or all of a wide area network (WAN), a local area network (LAN), the Internet, a provider device, a wireless base station, a dedicated line, and the like.

The data classification device 100 includes a data management unit 110, a receiving unit 120, a feature value converter 130, a classifier 140, a first storage unit 150, a second storage unit 160, and a learning device 170. The data management unit 110, the feature value converter 130, the classifier 140, and the learning device 170 may be implemented by, for example, causing a processor of the data classification device 100 to execute a program, may be implemented by hardware, such as a large scale integration (LSI), an application specific integrated circuit (ASIC), or a field-programmable gate array (FPGA), or may be implemented by software and hardware in cooperation with each other.

The receiving unit 120 is a device, such as a keyboard or a mouse, that receives input from a user. The first storage unit 150 and the second storage unit 160 are implemented by, for example, a random access memory (RAM), a read only memory (ROM), a hard disk drive (HDD), a flash memory, a hybrid storage device that is a combination of some of the above-described elements, or the like. Furthermore, a part or all of the first storage unit 150 and the second storage unit 160 may be implemented by an external device, such as a network-attached storage (NAS) or an external storage server, that can be accessed by the data classification device 100.

The data server 200 includes a control unit 210 and a communication unit 220. The control unit 210 may be implemented by, for example, causing a processor of the data server 200 to execute a program, may be implemented by hardware such as an LSI, an ASIC, or an FPGA, or may be implemented by software and hardware in cooperation with each other.

The communication unit 220 includes a network interface card (NIC), for example. The control unit 210 sequentially transmits stream data to the data classification device 100 through the network NW by using the communication unit 220. The “stream data” is a large amount of data that is endlessly streaming in chronological order, and includes, for example, entries posted in blog (weblog) services or entries posted in social networking services (SNSs). Furthermore, the stream data may include sensor data (a position measured by the global positioning system (GPS), acceleration, temperature, or the like) provided from various sensors to a control device or the like. The data classification device 100 uses the stream data received from the data server 200 as the classification target data.

### 2. Label Assignment Process by Data Classification Device

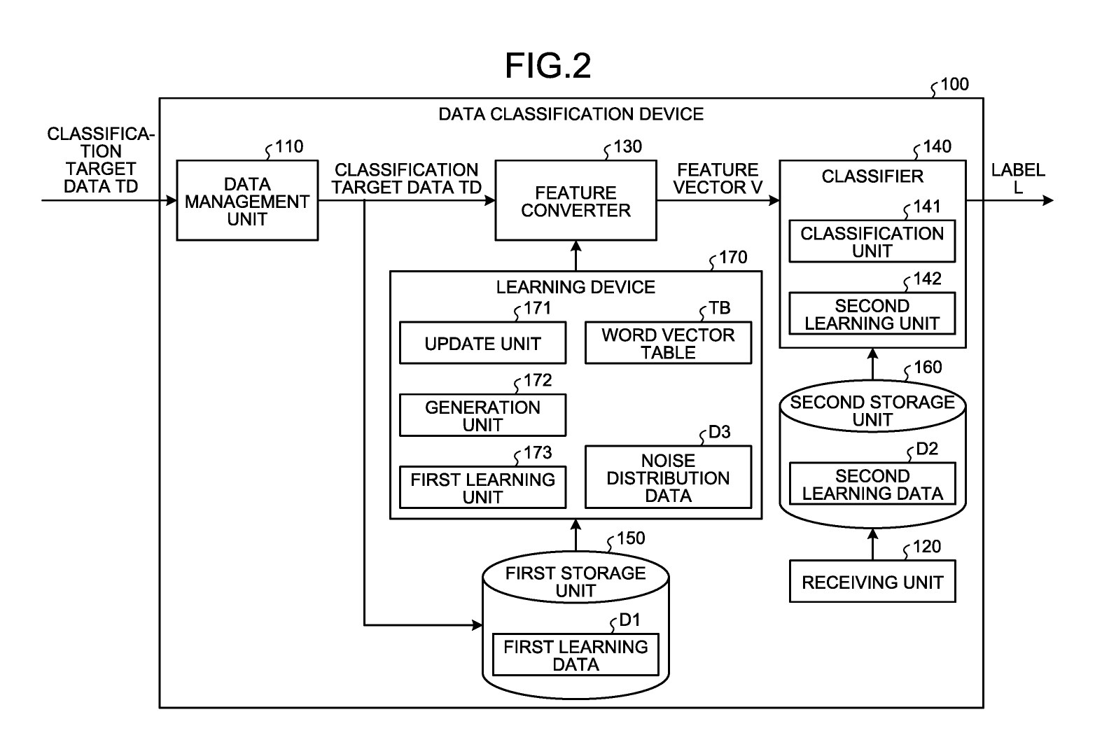

FIG. 2 is a block diagram illustrating a detailed configuration of the data classification device 100 according to the embodiment. The data classification device 100 receives stream data (hereinafter, referred to as classification target data TD) from the data server 200, and assigns a label to the received classification target data TD to classify the classification target data TD. The label is data for classifying the classification target data TD, and is data indicating a genre, such as “politics”, “economics”, or “sports”, to which the classification target data TD belongs. Classification operation performed by the data classification device 100 will be described in detail below.

The data management unit 110 receives the classification target data TD from the data server 200, and outputs the received classification target data TD to the feature value converter 130. Furthermore, the data management unit 110 stores the received classification target data TD as first training data D1 in the first storage unit 150.

The feature value converter 130 extracts a word from the classification target data TD output from the data management unit 110, and converts the extracted word into a vector representation, referred to as a word vector, by referring to a word vector table TB.

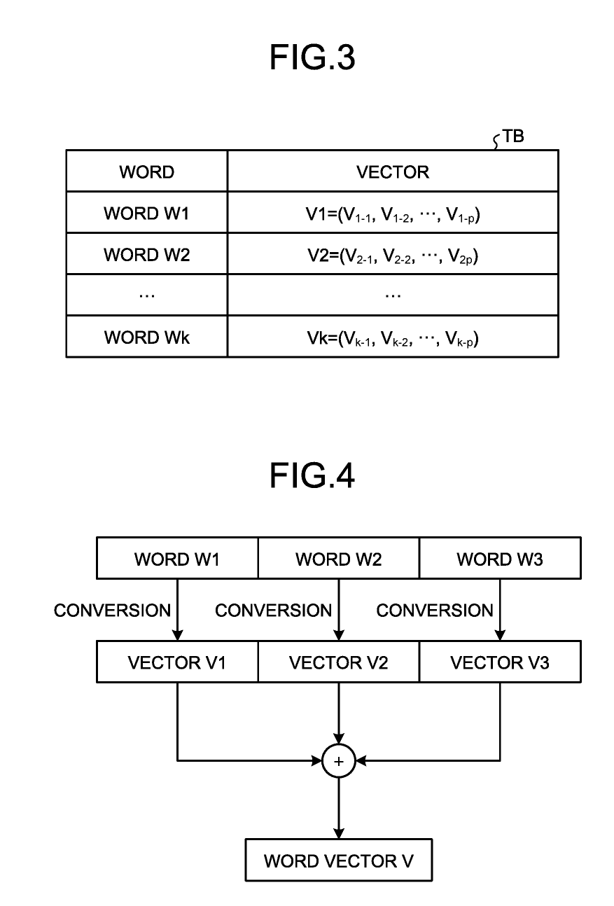

FIG. 3 is a schematic diagram illustrating an example of the word vector table TB according to the embodiment. The word vector table TB is stored in a table memory (not illustrated) managed by the learning device 170. In the word vector table TB, a p-dimensional vector is associated with each of k words. It is preferable to appropriately determine the upper limit k of words included in the word vector table TB depending on the capacity of the table memory. It is preferable to set the number of dimensions p of the vector to a value adequate for accurately classifying data. Meanwhile, each of the vectors included in the word vector table TB is calculated through a learning process performed by a first learning unit 173 to be described later.

For example, a vector V1=(V₁₋₁, V₁₋₂, . . . , V₁₋ₚ) is associated with a word W1, a vector V2=(V₂₋₁, V₂₋₂, . . . , V₂₋ₚ) is associated with a word W2, and a vector Vk=(Vₖ₋₁, Vₖ₋₂, . . . , Vₖ₋ₚ) is associated with a word Wk. The feature converter 130 converts all of words extracted from the classification target data TD into vectors, and calculates a feature vector V by adding up all of the converted vectors.

FIG. 4 is a schematic diagram illustrating an example of a method of calculating the feature vector V according to the embodiment. In the example illustrated in FIG. 4, it is assumed that the feature converter 130 extracts the word W1, the word W2, and a word W3 from the classification target data TD. In this case, the feature converter 130 converts the word W1 into the vector V1, the word W2 into the vector V2, and the word W3 into a vector V3 by referring to the vector representation table TB.

Subsequently, the feature converter 130 calculates the word vector V by obtaining a sum of the vector V1, the vector V2, and the vector V3. That is, in the example illustrated in FIG. 4, V=V1+V2+V3. Therefore, the number of dimensions of the feature vector V is p regardless of the number of words extracted from the classification target data TD.

As described above, the feature converter 130 converts the classification target data TD input from the data management unit 110 into the feature vector V by referring to the vector representation table TB managed by the learning device 170. Thereafter, the feature converter 130 outputs the converted feature vector V to the classifier 140.

Meanwhile, while the feature converter 130 calculates the sum of the word vectors as the feature vector V, embodiments are not limited to this example. For example, the feature converter 130 may calculate an average of the word vectors as the feature vector V, or may calculate any vector as the feature vector V as long as the contents of the word vectors are reflected. Also, the feature converter 130 may concatenate any other vector representations of the classification target data, such as bag-of-words vector, to the sum of the word vectors to enrich the feature vector.

The classifier 140 includes a classification unit 141 and a second learning unit 142, and classifies the classification target data TD by using a linear model, for example. When the feature converter 130 inputs the feature vector V, the classification unit 141 derives a label corresponding to the input feature vector V, and assigns the derived label to the classification target data TD. With the assignment, the classification target data TD is classified. The classification described herein includes classification in a broad sense, such as structured prediction to convert a word sequence into a label sequence.

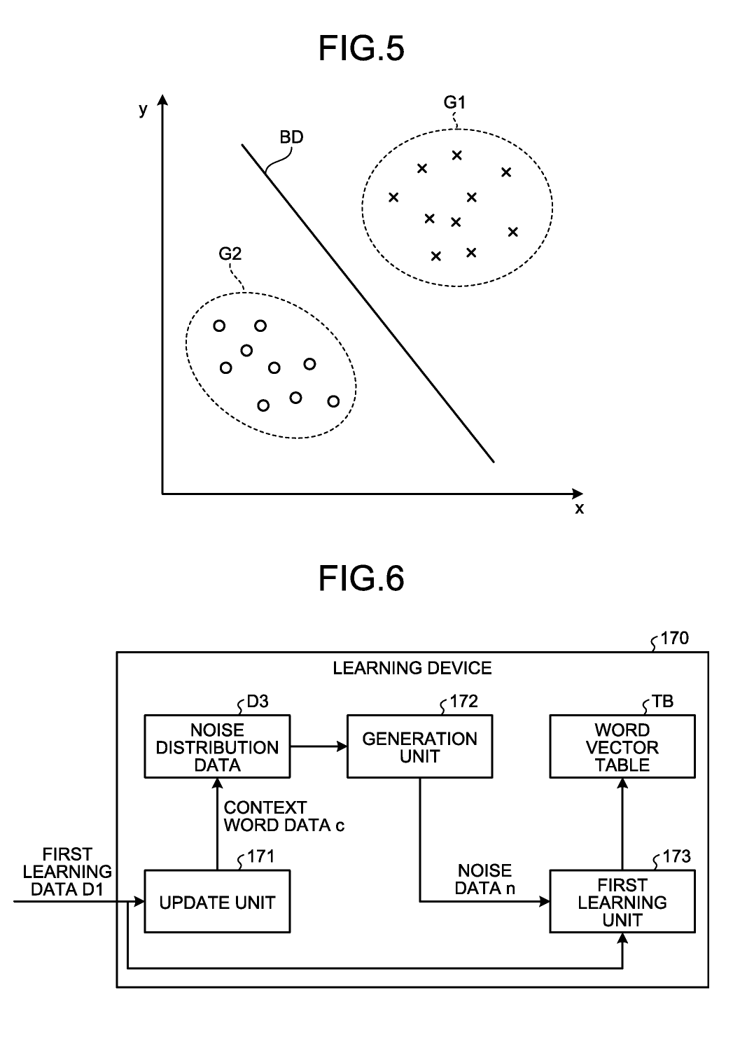

FIG. 5 is a schematic diagram for explaining a label assignment process according to the embodiment. Here, for simplicity of explanation, an example will be described in which each classification on target data is converted into a two-dimensional feature vector (x, y). In FIG. 5, the horizontal axis represents a value of the x component of the feature vector, and a vertical axis represents a value of the y component of the feature vector. A group G1 is a group of the feature vectors V to which a label L1 is assigned. A group G2 is a group of the feature vectors V to which a label L2 is assigned.

A boundary BD is a classification reference parameter used to determine whether the feature vector V belongs to the group G1 or the group G2. Meanwhile, the boundary BD is calculated through a learning process performed by the second learning unit 142 to be described later.

In the example illustrated in FIG. 5, if the feature vector V is located in the upper right with respect to the boundary BD, the classification unit 141 determines that the feature vector V belongs to the group G1, and assigns the label L1 to the classification target data TD. In contrast, if the feature vector V is located in the lower left with respect to the boundary BD, the classification unit 141 determines that the feature vector V belongs to the group G2, and assigns the label L2 to the classification target data TD.

As described above, the classification unit 141 assigns a label to the classification target data TD on the basis of the feature vector V given by the feature converter 130. Furthermore, the classification unit 141 transmits the classification target data TD, to which the label is assigned, to the data server 200. For example, the data server 200 uses the classification target data TD, to which the label is assigned and which is received from the data classification device 100, to classify entries posted in blog (weblog) services into genres or classify entries posted in social networking services (SNSs) into genres.

### 3. Learning of Conversion Process

Next, a learning process performed by the first learning unit 173 to learn a conversion process performed by the feature converter 130 will be described. The first learning unit 173 learns the conversion process of the feature converter 130 by using, as the first learning data D1, pieces of the input classification target data TD. In the embodiment, learning the conversion process of the feature converter 130 is updating the word vectors (i.e., V1, V2 . . . Vk) included in the word vector table TB to more appropriate values. In the embodiment, it is not appropriate to accumulate all pieces of the classification target data TD output from the data management unit 110 as the first learning data D1 and perform a process on the accumulated data. Therefore, the first learning unit 173 performs the learning process in real time every time a small amount of the first learning data D1 is received.

FIG. 6 is a block diagram illustrating a detailed configuration of the learning device 170 according to the embodiment. The learning device 170 includes an update unit 171, a generation unit 172, and the first learning unit 173. The learning device 170 reads the first learning data D1 from the first storage unit 150. The first learning data D1 read from the first storage unit 150 is input to the update unit 171 and the first learning unit 173.

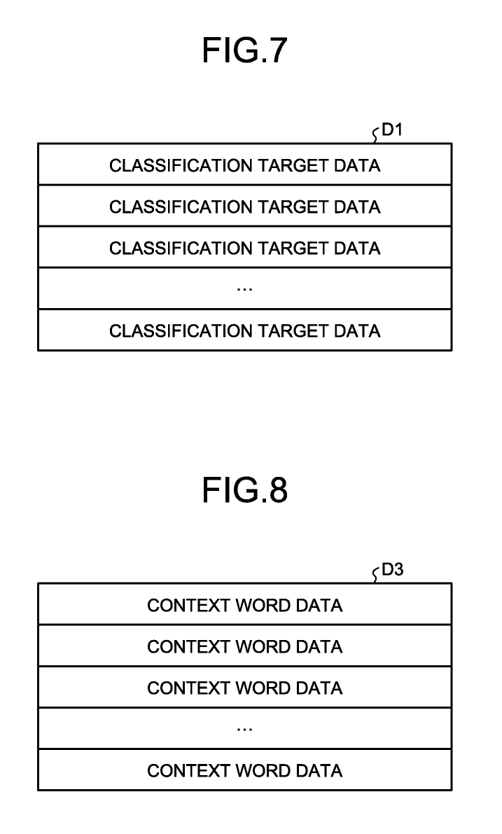

FIG. 7 is a schematic diagram illustrating an example of the first learning data D1 according to the embodiment. In an initial state, the first learning data D1 is not stored in the first storage unit 150. When the data management unit 110 receives the classification target data TD (the stream data) from the data server 200, the data management unit 110 stores the received classification target data TD in the first storage unit 150. The data management unit 110 accumulates the received classification target data TD in the first storage unit 150 every time receiving the classification target data TD. Therefore, the classification target data TD is used not only for the conversion process performed by the feature converter 130 but also for the learning process performed by the first learning unit 173.

As illustrated in FIG. 7, the first learning data D1 includes a plurality of pieces of the classification target data TD received by the data management unit 110. It is preferable to appropriately determine the upper limit of the classification target data TD included in the first learning data D1 depending on the capacity of the first storage unit 150. If the number of pieces of the classification target data TD stored as the first learning data D1 in the first storage unit 150 reaches the upper limit (in other words, if the first learning data D1 stored in the first storage unit 150 exceeds a predetermined amount), the first learning unit 173 starts the learning process of learning the conversion process performed by the feature converter 130.

The update unit 171 extracts a target word and a context word from the first learning data D1 read from the first storage unit 150. The target word is a word to be a target of the learning process performed by the first learning unit 173. The context word is a word located near the target word (for example, within five words from the target word). The update unit 171 updates noise distribution data D3 indicating a relationship between noise data and a probability value by using context word data c indicating the extracted context word.

FIG. 8 is a schematic diagram illustrating an example of the noise distribution data D3 according to the embodiment. The noise distribution data D3 includes pieces of the context word data c. While details will be described later, the context word data c included in the noise distribution data D3 is used as noise data n in the learning process performed by the first learning unit 173. While it is not illustrated in FIG. 8, each of the pieces of the context word data c included in the noise distribution data D3 is associated with a probability value to be described later.

In an initial state, the context word data c is not included in the noise distribution data D3. When the update unit 171 extracts a context word from the first learning data D1, the update unit 171 adds the context word data c indicating the extracted context word to the noise distribution data D3.

For example, it is assumed that the total number of pieces of the already-extracted context word data c is N, and the maximum number of pieces of the context word data c that can be registered in the noise distribution data D3 is T. In this case, the update unit 171 updates the noise distribution data D3 with a probability of T/N. However, if T>N, T/N=1. Specifically, when T>N, the update unit 171 adds the extracted context word data c to the noise distribution data D3. In contrast, if TN, the update unit 171 determines whether to update the noise distribution data D3 with a probability of T/N. When updating the noise distribution data D3, the update unit 171 randomly selects one piece of the context word data from the pieces of the context word data c registered in the noise distribution data D3, and rewrites the piece of the selected context word data into newly-extracted context word data. The update unit 171 repeats the above-described process every time the context word data c is extracted.

Meanwhile, the update process performed by the update unit 171 is not limited to the above-described example. For example, if the number of pieces of the context word data c registered in the noise distribution data D3 has not reached the maximum number T, the update unit 171 may add the extracted context word data c to the noise distribution data D3. In contrast, if the number of pieces of the context word data c registered in the noise distribution data D3 has reached the maximum number T, the update unit 171 may rewrite each of entries in the noise distribution data D3 with the extracted context word data c with a probability of 1/N.

As illustrated in FIG. 8, the noise distribution data D3 includes a plurality of pieces of the context word data c extracted by the update unit 171. It is preferable to appropriately determine the upper limit of the context word data c included in the noise distribution data D3 depending on the capacity of a memory (not illustrated) for storing the noise distribution data D3.

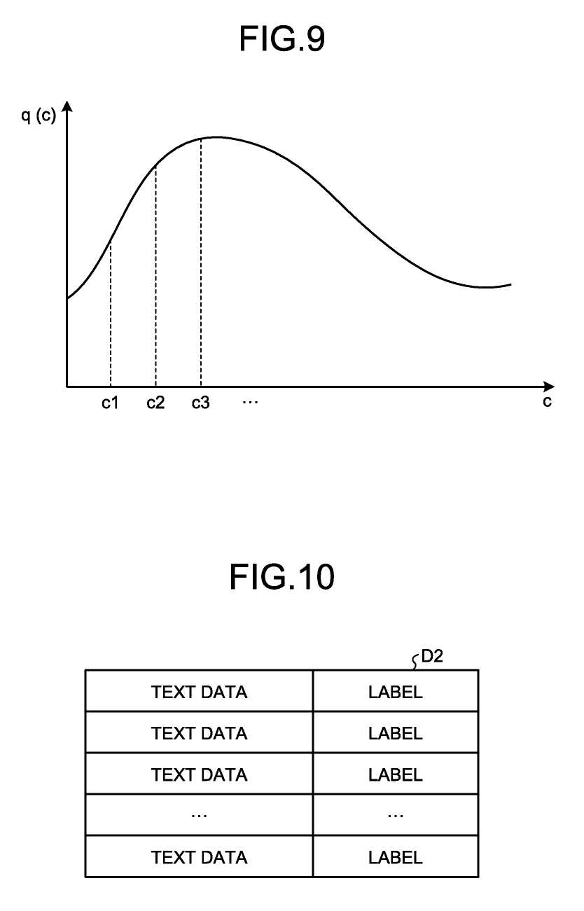

FIG. 9 is a schematic diagram illustrating a noise distribution q(c) as an example of the noise distribution data D3 according to the embodiment. Specifically, the noise distribution data D3 is the noise distribution q(c) indicating a probability distribution of the context word data c that is used as noise data. For example, in the noise distribution q(c), a plurality of pieces of the context word data c (c1, c2, c3, . . . ) are associated with respective probability values. The update unit 171 calculates, as the probability value, a probability of appearance of a context word extracted from the first learning data D1, and updates the noise distribution data D3 by using the calculated probability value and the extracted context word data c. Meanwhile, the update unit 171 updates the noise distribution data D3 every time the first learning data D1 is input.

The generation unit 172 generates the noise data n by using the noise distribution data D3 updated by the update unit 171. For example, the generation unit 172 selects one piece of the context word data c on the basis of the noise distribution q(c) illustrated in FIG. 9. Here, the generation unit 172 selects the context word data c having a higher probability value with a higher probability. The generation unit 172 outputs the piece of the selected context word data c as the noise data n to the first learning unit 173.

The first learning unit 173 optimizes a loss function L_{NCE} by using the stochastic gradient method with respect to all pairs (w, c) of target word data w, which indicates a target word included in the first learning data D1, and the context word data c. With the optimization, the first learning unit 173 can update the word vectors included in the word vector table TB to more appropriate values.

Specifically, the first learning unit 173 updates a word vector corresponding to the target word data w, a word vector corresponding to the context word data c, and a word vector corresponding to the noise data n based on formulas (1) to (3) described below by using a value obtained by a partial derivative of the loss function L_{NCE}. Here, arrows are symbols indicating vector representations.

$$\begin{matrix}{w}^{->} ← {w}^{->} - α \frac{\partial {L}_{NCE}}{\partial {w}^{->}} & ( 1 ) \\ {c}^{->} ← {c}^{->} - α \frac{\partial {L}_{NCE}}{\partial {c}^{->}} & ( 2 ) \\ {n}^{->} ← {n}^{->} - α \frac{\partial {L}_{NCE}}{\partial {n}^{->}} & ( 3 )\end{matrix}$$

In formulas (1) to (3), α is a learning rate. For example, the first learning unit 173 calculates the learning rate α by using the AdaGrad method. L_{NCE} in formulas (1) to (3) is the loss function. The first learning unit 173 calculates the loss function L_{NCE} based on formula (4) described below. Meanwhile, it is assumed that a single piece of noise data is used in the loss function for simplicity of explanation; however, it may be possible to use a plurality of pieces of noise data.

$${L}_{NCE} = log \frac{q ( c )}{exp ( {w}^{->} \cdot {c}^{->} ) + q ( c )} + log \frac{exp ( {w}^{->} \cdot {n}^{->} )}{exp ( {w}^{->} \cdot {n}^{->} ) + q ( n )} \qquad ( 4 )$$

As described above, the first learning unit 173 performs the learning process of learning the conversion process of the feature converter 130 through unsupervised learning by using the first learning data D1. With this process, the first learning unit 173 can update the word vectors included in the word vector table TB to more appropriate values.

In the conventional technology, when a learning process of learning the conversion process of the feature converter 130 is to be performed, operation of the classification unit 141 needs to be stopped and thereafter a batch process needs to be performed by using a large-capacity storage unit that stores data used in the learning process. Therefore, it is difficult to perform the learning process of learning the conversion process of the feature converter 130 and a data classification process in parallel, and thus it is difficult to efficiently perform the learning process of learning the conversion process of the feature converter 130 and the data classification process.

In contrast, in the embodiment, the classification target data TD output from the data management unit 110 is stored as the first learning data D1 in the first storage unit 150. Furthermore, when the learning process of learning the conversion process of the feature converter 130 is completed, the first learning unit 173 deletes the first learning data (the classification target data) from the first storage unit 150. When a storage area in the first storage unit 150 is released by the deletion, the data management unit 110 stores the classification target data TD newly received from the data server 200 as the first learning data in the first storage unit 150. With this operation, the data classification device 100 can perform the learning process of learning the conversion process of the feature converter 130 by using the first storage unit 150 with a small capacity.

While it is explained that, in the embodiment, the first learning unit 173 deletes, from the first storage unit 150, the first learning data used in the learning process of learning the conversion process of the feature converter 130, embodiments are not limited to this example. For example, the first learning unit 173 may disable the first learning data used in the learning process of learning the conversion process of the feature converter 130 by assigning an “overwritable” flag.

The first learning unit 173 repeats the above-described process by using other learning data included in the first learning data D1. With this operation, the values of the word vectors included in the word vector table TB are optimized. For example, vectors of mutually-related words are updated with close values.

As described above, the first learning unit 173 updates a first vector and a second vector included in the word vector table TB such that the first vector associated with the target word data w (a first word) included in the first learning data D1 and the second vector associated with the context word data c (a second word) related to the target word data w have close values. Specifically, if the context word data c (the second word) is located within a predetermined words (for example, within five words) from the target word data w (the first word) in the first learning data D1, the first learning unit 173 updates the first vector and the second vector in the word vector table TB such that the first vector and the second vector have close values. With this operation, the first vector and the second vector are updated to more appropriate values.

Furthermore, the first learning unit 173 calculates the loss function L_{NCE} by using the first vector, the second vector, and a third vector associated with the noise data n, and updates the first vector, the second vector, and the third vector by using a values obtained by a partial derivative of the calculated loss function L_{NCE}. With this operation, the first vector, the second vector, and the third vector are updated to more appropriate values.

If a word that is not included in the word representation table TB is extracted from the first learning data D1, the first learning unit 173 newly adds the extracted word to the word vector table TB, and associates the extracted word with a vector defined in advance. The vector associated with the newly-added word is updated to a more appropriate value through the learning process performed by the first learning unit 173.

Meanwhile, if the total number of words registered in the word vector table TB has reached the upper limit, the first learning unit 173 deletes a word with a low appearance frequency from the word vector table TB, and adds the newly-extracted word to the word vector table TB. With this operation, it is possible to prevent an overflow of the table memory that stores therein the word vector table TB due to an increase in the number of words.

Meanwhile, the first learning unit 173 may update the word vector table TB by performing a learning process using the noise data n as negative example data. For example, the first learning unit 173 may update a word vector corresponding to the target word data w, a word vector corresponding to the context word data c, and a word vector corresponding to the noise data n (the negative example data) by using a loss function L_{NS} represented by formula (5) described below, instead of the loss function L_{NCE}.

$${L}_{NS} = log \frac{1}{exp ( {w}^{->} \cdot {c}^{->} ) + 1} + log \frac{exp ( {w}^{->} \cdot {n}^{->} )}{exp ( {w}^{->} \cdot {n}^{->} ) + 1} \qquad ( 5 )$$

Furthermore, the first learning unit 173 may update the word vector table TB by using data different from the first learning data D1 and the noise data n. For example, the generation unit 172 may generate a probability value of the noise data n in addition to the noise data n. Moreover, the first learning unit 173 may update the word vector table TB by using the first learning data D1 read from the first storage unit 150 and by using the noise data n and the probability value generated by the generation unit 172.

### 4. Learning of Classification Process

Next, a learning process performed by the second learning unit 142 to learn a classification process performed by the classification unit 141 will be described. The second learning unit 142 learns the classification process of the classification unit 141 by using second learning data D2 in which a label is assigned to the same type of data as the classification target data TD. In the embodiment, learning the classification process of the classification unit 141 is updating a classification reference parameter (for example, the boundary BD in FIG. 5) used to classify the word vector V with a more appropriate parameter.

FIG. 10 is a schematic diagram illustrating an example of the second learning data D2 according to the embodiment. A user inputs text data including a sentence and a label (correct data) corresponding to the text data to the data classification device 100. The receiving unit 120 receives the text data and the label (the correct data) input by the user, and stores the text data and the label as the second learning data D2 in the second storage unit 160. As described above, the second learning data D2 is data generated by the user and stored in the second storage unit 160, and, unlike the first learning data D1, need not be data that is increased by being input on an as-needed basis.

As illustrated in FIG. 10, the second learning data D2 includes a plurality of pieces of learning data in which the text data and the label are associated with each other. It is preferable to appropriately determine the upper limit of the learning data included in the second learning data D2 depending on the capacity of the second storage unit 160. The second learning unit 142 starts the learning process for the classification unit 141 when the first learning unit 173 updates the word vectors included in the word vector table TB, for example.

First, the second learning unit 142 reads the learning data (the text data and the label) from the second learning data D2 stored in the second storage unit 160. Here, the number of pieces of learning data read by the second learning unit 142 is appropriately determined depending on the frequency of the learning process performed by the second learning unit 142. For example, the second learning unit 142 may read a single piece of learning data when the learning process is frequently performed, or may read all pieces of learning data from the second storage unit 160 when the learning process is performed only once in a while. The second learning unit 142 outputs the text data included in the learning data to the feature converter 130. The feature converter 130 converts the text data output from the second learning unit 142 into the feature vector V by referring to the word vector table TB managed by the learning device 170. Thereafter, the feature converter 130 outputs the converted feature vector V to the classifier 140.

Subsequently, the second learning unit 142 updates the classification reference parameter (the boundary BD in FIG. 5) by using the feature vector V input from the feature converter 130 and the label (the correct data) included in the learning data read from the second storage unit 160. The second learning unit 142 may calculate the classification reference parameter by using any of conventional techniques. For example, the second learning unit 142 may calculate the classification reference parameter by optimizing the hinge loss function of the support vector machine (SVM) by the stochastic gradient method, or may calculate the classification reference parameter by using a perceptron algorithm.

The second learning unit 142 sets the calculated classification reference parameter in the classification unit 141. The classification unit 141 performs the above-described classification process by using the classification reference parameter set by the second learning unit 142.

As described above, the second learning unit 142 updates the classification reference parameter (for example, the boundary BD in FIG. 5) used to classify the feature vector V converted by the feature converter 130, on the basis of the second learning data D2 including information indicating a positive example or a negative example. Specifically, the second learning unit 142 reads, from the second storage unit 160, the second learning data D2 to which the label is assigned, and outputs the second learning data D2 to the feature converter 130. The feature converter 130 converts the second learning data D2 output from the second learning unit 142 into the feature vector V, and outputs the converted feature vector V to the second learning unit 142. The second learning unit 142 updates the classification reference parameter on the basis of the feature vector V output from the feature converter 130 and the label assigned to the second learning data D2. With this operation, it is possible to update the classification reference parameter (the boundary BD in FIG. 5) used to classify the feature vector V to a more appropriate value.

Meanwhile, even when the learning process of learning the classification process of the classification unit 141 is completed, the second learning unit 142 does not delete the learning data (the text data and the label) used in the learning from the second storage unit 160. That is, the second learning unit 142 repeatedly uses the second learning data D2 accumulated in the second storage unit 160 when performing the learning process of learning the classification process of the classification unit 141. Therefore, it is possible to prevent the second learning unit 142 from failing to perform the learning process due to emptiness of the second storage unit 160.

Meanwhile, the second learning unit 142 may assign a flag to the second learning data used in the learning process of learning the classification process of the classification unit 141, and delete the data to which the flag is assigned. With this operation, it is possible to prevent an overflow of the second storage unit 160.

The second learning unit 142 repeats the learning process by using other learning data (text data and a label) included in the second learning data D2 every time the first learning unit 173 performs the learning process. The second learning data D2 is data to which the label (correct data) input by a user is assigned. Therefore, the second learning unit 142 can improve the accuracy of the classification process performed by the classification unit 141 every time performing the learning process for the classification unit 141 by using the second learning data D2.

Meanwhile, the feature converter 130 and the classification unit 141 perform the processes asynchronously with the processes performed by the first learning unit 173 and the second learning unit 142. Therefore, it is possible to efficiently perform the learning process of learning the conversion process of the feature converter 130 and the learning process of learning the classification process of the classification unit 141.

Even if there is a technology for sequentially learning vector representations, it is difficult to perform a learning process in real time while reading pieces of learning data one by one, or it is difficult to re-update a vector corresponding to a word that has been learned once. However, the first learning unit 173 of the embodiment can operate in real time in parallel to the processes performed by the feature converter 130 and the classification unit 141 even when pieces of the learning data are read one by one from the first storage unit 150. Furthermore, the first learning unit 173 of the embodiment can incrementally update a word vector in the already-learned word vector table TB to a more appropriate value every time performing learning by using the first learning data D1.

### 5. Flowchart of Label Assignment Process

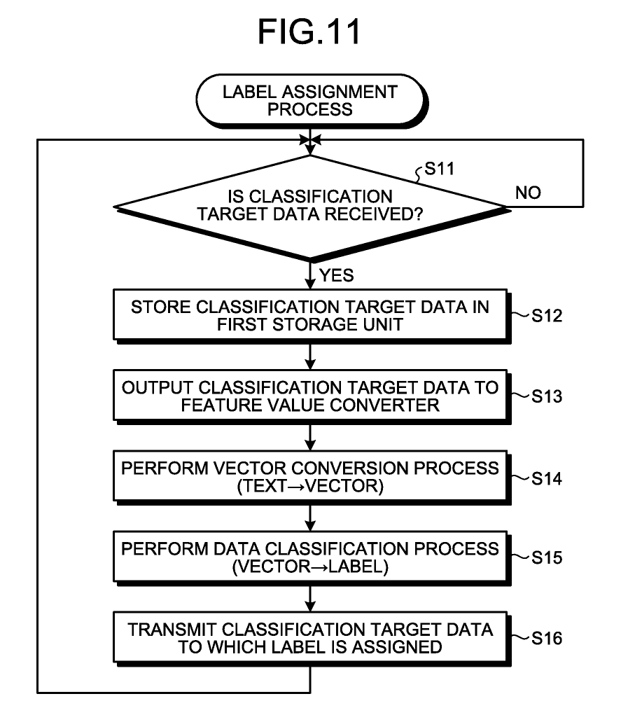

FIG. 11 is a flowchart illustrating the label assignment process according to the embodiment. The process in this flowchart is performed by the data classification device 100.

First, the data management unit 110 determines whether the classification target data TD is received from the data server 200 (S11). When determining that the classification target data TD is received from the data server 200, the data management unit 110 stores the received classification target data TD as the first learning data D1 in the first storage unit 150 (S12).

Subsequently, the data management unit 110 outputs the received classification target data TD to the feature converter 130 (S13). The feature converter 130 converts the classification target data TD input from the data management unit 110 into the feature vector V by referring to the word vector table TB managed by the learning device 170 (S14). The feature converter 130 outputs the converted feature vector V to the classification unit 141.

The classification unit 141 classifies the classification target data TD by assigning a label to the classification target data TD on the basis of the feature vector V input from the feature converter 130 and the classification reference parameter (the boundary BD in FIG. 5) (S15). The classification unit 141 transmits, to the data server 200, the classification target data TD to which the label is assigned (S16), and returns the process to S11 described above.

### 6. Flowchart of First Learning Process

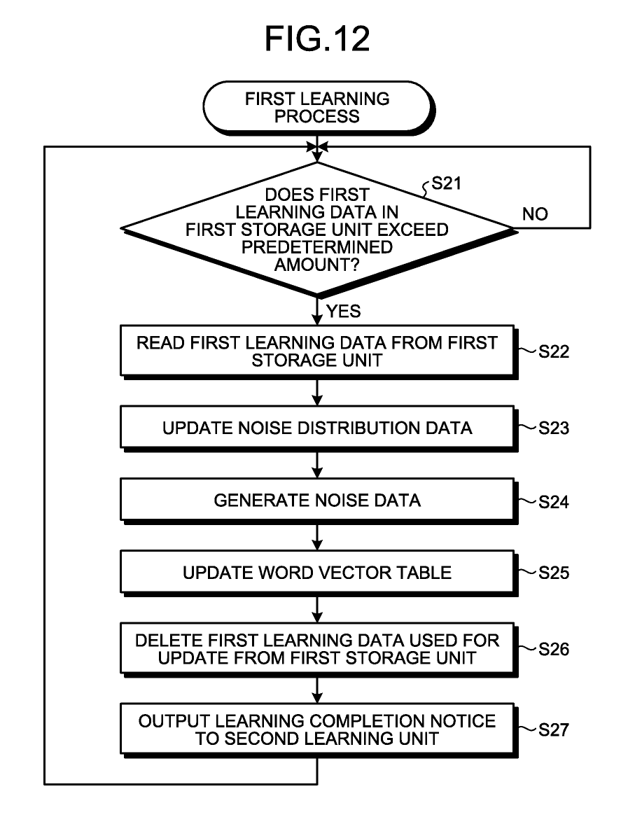

FIG. 12 is a flowchart illustrating the learning process (a first learning process) of learning the conversion process of the feature converter 130 according to the embodiment. The process in this flowchart is performed by the learning device 170.

First, the learning device 170 determines whether the first learning data D1 in the first storage unit 150 exceeds a predetermined amount (S21). When determining that the first learning data D1 in the first storage unit 150 exceeds the predetermined amount, the learning device 170 reads the first learning data D1 from the first storage unit 150 (S22).

Subsequently, the update unit 171 of the learning device 170 updates the noise distribution data D3 by using the first learning data D1 read from the first storage unit 150 (S23). Furthermore, the generation unit 172 generates the noise data n by using the noise distribution data D3 updated by the update unit 171 (S24).

The first learning unit 173 updates the word vector table TB by using the first learning data D1 read from the first storage unit 150 and the noise data n generated by the generation unit 172 (S25). With this operation, it is possible to update the word vector included in the word vector table TB to a more appropriate value. Subsequently, the first learning unit 173 deletes the first learning data D1 used for the update from the first storage unit 150 (S26). Thereafter, the first learning unit 173 outputs a learning completion notice indicating completion of the first learning process to the second learning unit 142 (S27), and returns the process to S21 described above.

### 7. Flowchart of Second Learning Process

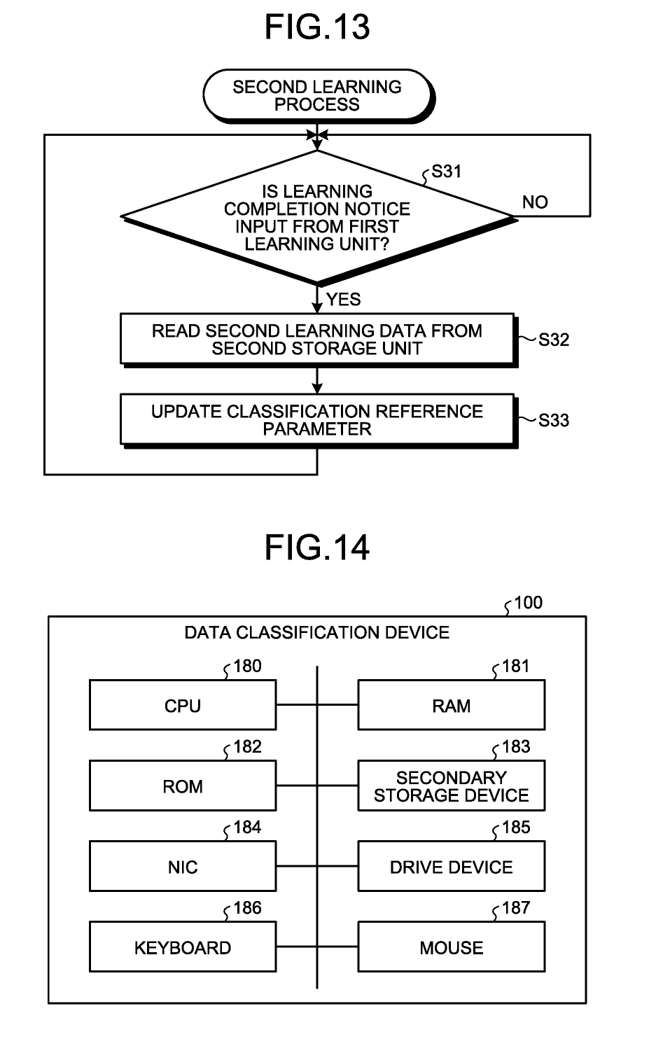

FIG. 13 is a flowchart illustrating the learning process (a second learning process) of learning the classification process of the classification unit 141 according to the embodiment. The process in this flowchart is performed by the second learning unit 142.

First, the second learning unit 142 determines whether the learning completion notice is input from the first learning unit 173 (S31). When determining that the learning completion notice is input from the first learning unit 173, the second learning unit 142 reads the second learning data D2 from the second storage unit 160 (S32).

Subsequently, the second learning unit 142 updates the classification reference parameter (for example, the boundary BD in FIG. 5) by using the read second learning data D2 (S33). With this operation, it is possible to improve the accuracy of the classification process performed by the classification unit 141. Thereafter, the second learning unit 142 returns the process to S31 described above.

Meanwhile, the data classification device 100 performs the process in the flowchart illustrated in FIG. 11, the process in the flowchart illustrated in FIG. 12, and the process in the flowchart illustrated in FIG. 13 in parallel. Therefore, the data classification device 100 can perform the learning process of learning the conversion process of the feature converter 130 and the learning process of learning the classification process of the classification unit 141 without suspending the label assignment process. Consequently, the data classification device 100 can efficiently perform the learning process of learning the conversion process of the feature converter 130, the learning process of learning the classification process of the classification unit 141, and the data classification process.

### 8. Hardware Configuration

FIG. 14 is a schematic diagram illustrating an example of a hardware configuration of the data classification device 100 according to the embodiment. The data classification device 100 includes, for example, a central processing unit (CPU) 180, a RAM 181, a ROM 182, a secondary storage device 183, such as a flash memory or an HDD, a NIC 184, a drive device 185, a keyboard 186, and a mouse 187, all of which are connected to one another via an internal bus or a dedicated communication line. A portable storage medium, such as an optical disk, is attached to the drive device 185. A program stored in the secondary storage device 183 or the portable storage medium attached to the drive device 185 is loaded onto the RAM 181 by a direct memory access (DMA) controller (not illustrated) or the like and executed by the CPU 180, so that the functional units of the data classification device 100 are implemented.

### 9. Other Embodiments

In the above-described embodiment, the classification target data TD received by the data management unit 110 is input to the feature converter 130 and stored as the first learning data D1 in the first storage unit 150; however, embodiments are not limited to this example. For example, input of the classification target data TD to the feature converter 130 and input of the classification target data TD to the first storage unit 150 may be performed in separate systems.

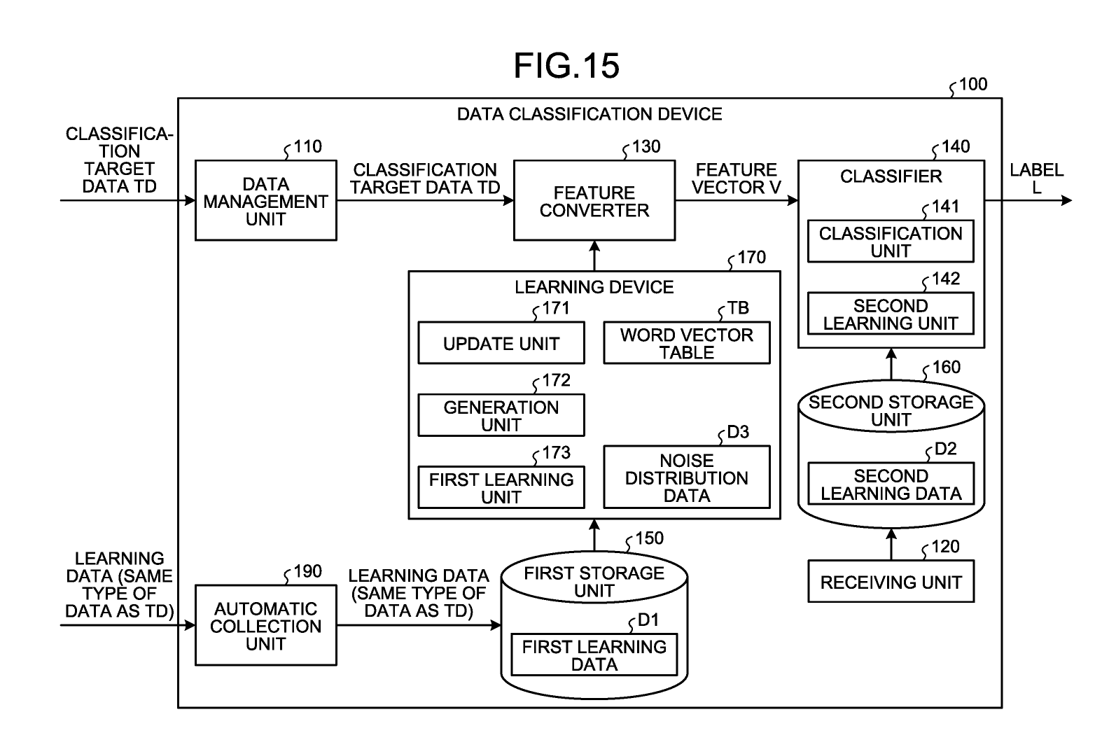

FIG. 15 is a block diagram illustrating a detailed configuration of a data classification device 100 according to another embodiment. As illustrated in FIG. 15, the data classification device 100 further includes an automatic collection unit 190 that automatically collects the same type of learning data as the classification target data TD, and the automatic collection unit 190 may store the collected learning data as the first learning data D1 in the first storage unit 150. As described above, the data classification device 100 may include the automatic collection unit 190 that stores the collected learning data as the first learning data D1 in the first storage unit 150, separately from the data management unit 110 that inputs the classification target data TD to the feature converter 130.

Furthermore, while it is explained that the data classification device 100 classifies the classification target data TD that is text data and assigns a label to the data, embodiments are not limited to this example. For example, the data classification device 100 may classify the classification target data TD that is audio data and assigns a label to the data, or may classify the classification target data TD that is image data and assigns a label to the data. When the data classification device 100 classifies the image data, the feature converter 130 may convert the input image data into a vector representation by using an auto-encoder, or the first learning unit 173 may optimize the auto-encoder by using the stochastic gradient method. Furthermore, it may be possible to use a neural network using a pixel of the image data as an input, instead of the vector representation table TB.

Moreover, while it is explained that the first learning unit 173 starts the learning process of learning the feature converter 130 when the first learning data D1 stored in the first storage unit 150 exceeds a predetermined amount, embodiments are not limited to this example. For example, the first learning unit 173 may start the learning process of learning the feature converter 130 before the first learning data D1 stored in the first storage unit 150 exceeds a predetermined amount. Furthermore, the first learning unit 173 may start the learning process of learning the feature converter 130 when the first storage unit 150 becomes full.

Moreover, while it is explained that the feature converter 130 converts a word into a vector, the feature converter 130 may convert a word into other feature vector. Furthermore, while it is explained that the feature converter 130 refers to the word vector table TB when converting a word into a feature representation, the feature value converter 130 may refer to other information sources.

As described above, the data classification device 100 according to the embodiment includes the feature converter 130, the update unit 171, the generation unit 172, and the first learning unit 173. The feature converter 130 converts the input classification target data TD into the word vector V. The update unit 171 updates the noise distribution data D3 indicating a relationship between noise data and a probability value by using the classification target data TD as the first learning data D1. The generation unit 172 generates the noise data n by using the noise distribution data D3 updated by the update unit 171. The first learning unit 173 learns the conversion process of the feature value converter 130 by using the first learning data D1 and the noise data n. Therefore, the data classification device 100 can efficiently learn the conversion process of converting data into a feature vector

While it is explained that the disclosed technology is applied to the data classification device 100, the disclosed technology may be applied to other information processing apparatuses. For example, the disclosed technology may be applied to a learning device that includes a conversion unit that converts processing target data into a feature vector by using a word vector table and a learning unit that learns the conversion process performed by the conversion unit. For example, a synonym search system having a learning function is implemented by the above-described learning device and a synonym search device that searches for a synonym by using a word vector table.

According to at least one aspect of the embodiments, it is possible to efficiently learn a conversion process of converting data into a feature vector.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a conversion unit that converts input target data into a feature vector
an update unit that updates, by using the target data as first learning data, noise distribution data indicating a relationship between noise data extracted from the first learning data and a probability value;
a generation unit that generates noise data by using the noise distribution data updated by the update unit; and
a first learning unit that learns a conversion process performed by the conversion unit by using the first learning data and the noise data.

2. The information processing apparatus according to claim 1, wherein
the conversion unit converts the target data into a vector data as the feature vector by referring to a word vector table in which a word and a vector are associated with each other, and
the first learning unit updates the vector included in the word vector table by using the first learning data and the noise data.

3. The information processing apparatus according to claim 2, wherein the first learning unit updates a first vector and a second vector included in the word vector table such that the first vector and the second vector have close values, the first vector being associated with a first word included in the first learning data and the second vector being associated with a second word related to the first word.

4. The information processing apparatus according to claim 3, wherein the update unit extracts the second word from the first learning data, and updates the noise distribution data by using the extracted second word as the noise data.

5. The information processing apparatus according to claim 3, wherein
the second word is a word located within a predetermined number of words from the first word in the first learning data, and
the noise distribution data is a data indicating a probability distribution of the second word.

6. The information processing apparatus according to claim 3, wherein the first learning unit calculates a loss function by using the first vector, the second vector, and a third vector associated with the noise data, and updates the first vector, the second vector, and the third vector by using a value obtained by a partial derivative of the calculated loss function.

7. The information processing apparatus according to claim 1, wherein
the generation unit generates a probability value of the noise data in addition to the noise data, and
the first learning unit learns the conversion process of the conversion unit by using the first learning data and by using the noise data and the probability value generated by the generation unit.

8. The information processing apparatus according to claim 1, further comprising:
a classification unit that assigns a label to the target data on the basis of the feature vector converted by the conversion unit; and
a second learning unit that leans a classification process performed by the classification unit by using second learning data in which a label is assigned to a same type of data as the target data.

9. The information processing apparatus according to claim 8, wherein the second learning unit updates a classification reference parameter used to classify the feature vector converted by the conversion unit, on the basis of the second learning data including information indicating one of a positive example and a negative example.

10. The information processing apparatus according to claim 9, wherein
the second learning unit outputs the second learning data to the conversion unit,
the conversion unit converts the second learning data output from the second learning unit into the feature vector, and outputs the converted feature vector to the second learning unit, and
the second learning unit updates the classification reference parameter on the basis of the feature vector output from the conversion unit and the label assigned to the second learning data.

11. The information processing apparatus according to claim 8, wherein the conversion unit and the classification unit perform processes asynchronously with processes performed by the first learning unit and the second learning unit.

12. The information processing apparatus according to claim 1, wherein
the first learning data is stored in a first storage unit, and
the first learning unit starts the learning process of learning the conversion process of the conversion unit when the first learning data stored in the first storage unit exceeds a predetermined amount.

13. The information processing apparatus according to claim 12, wherein the first learning unit deletes or disables the first learning data from the first storage unit when the learning process of learning the conversion process of the conversion unit is completed.

14. The information processing apparatus according to claim 1, wherein the generation unit selects noise data having a higher probability value with a higher probability from the noise distribution data, and outputs the selected noise data to the first learning unit.

15. An information processing method comprising:
converting input target data into a feature vector;
updating noise distribution data indicating a relationship between noise data and a probability value by using the target data as first learning data;
generating noise data by using the noise distribution data updated at the updating; and
first learning including learning a conversion process performed at the converting by using the first learning data and the noise data.

16. A non-transitory computer readable storage medium having stored therein a computer program that causes a computer to execute:
converting input target data into a feature vector;
updating noise distribution data indicating a relationship between noise data and a probability value by using the target data as first learning data;
generating noise data by using the noise distribution data updated at the updating; and
first learning including learning a conversion process performed at the converting by using the first learning data and the noise data.
